(19) United States
(12) Patent Application Publication
(10) Pub. No.: US 2006/0006638 A1
(43) Pub. Date: Jan. 12, 2006

(54) Fold oriented album page, and fabrication

(76) Inventor: Alan Chun Ming Chiu, Kowloon (HK)

Correspondence Address: WILLIAM W. HAEFLIGER, 201 S. LAKE AVE, SUITE 512, PASADENA, CA, 91101, US

(21) Appl. No.: 10/886,024

(22) Filed: Jul. 7, 2004

(51) Int. Cl. B42D 1/00

(52) U.S. Cl. 281/38

(57) ABSTRACT

An album page adapted for carriage by an album post or posts, comprising first, second, third and fourth layers each less than 1/16 inch thick, and extending in substantially parallel relation, the first and second layers extending in superposed relation and defining a through opening or openings to receive an album post or posts, the third and fourth layers extending in generally superposed relation, in offset relation to the first and second layers, and defining a pocket to receive an album photo or other graphic sheet, the second and fourth layers interconnected at a single layer that defines a flexible page folding preferred locus, between the first and third layers.

### BACKGROUND OF THE INVENTION

This invention relates generally to improvements in albums, as for example photograph albums, and more particularly to improvements to pages of albums that facilitate folding or turning of the pages which typically mount and/or display photographs and/or memoranda elements.

There is continual need for improvements in such albums and/or album pages, to assist, or enhance, ease of their usage. For example there is need for ways to easily and rapidly mount photographs on album pages, and to enable removal of mounted photographs without damage either to album pages or to the photographs during their removal. This is in turn facilitated by easy folding of the successive pages, in the album.

### SUMMARY OF THE INVENTION

It is a major object of the invention to provide improved apparatus meeting the above needs.

The improved and preferred album page configured in accordance with the invention includes:
a) first, second, third and fourth layers each less than 1/16 inch thick, and extending in substantially parallel relation,
b) the first and second layers extending in superposed relation and defining a through opening or openings to receive an album post or posts,
c) the third and fourth layers extending in generally superposed relation, in offset relation to the first and second layers, and defining a pocket to receive an album photo or other graphic sheet,
d) the second and fourth layers interconnected at a single layer that defines a flexible page folding locus, between the first and third layers.

As will be seen, the second and fourth layers are configured on a common sheet of flexible plastic material. In this regard, each of the layers typically consists of flexible plastic material, whereby the locally effectively relevant thickness of the page at the defined single layer provides a preferred folding or foldable locus between the first and third layers.

Another object is to provide a layer extension between said second and fourth layers, to provide said folding locus.

A further object is to provide two primary rows of connections interconnecting said first and second layers, the through opening or openings located between said two primary rows, whereby the first and second layers are locally stiffened against folding, as at the post hole locations. Also, a secondary row of connectors is typically provided to interconnect the third and fourth layers which are locally stiffened against folding.

An added object is to provide multiple album pages as referred to, which become stacked with the through openings in alignment, and the folding loci in alignment. Such loci may comprise narrow bands of layer extension material, and of widths between ⅞ and ⅝ inch.

These and other objects and advantages of the invention, as well as the details of an illustrative embodiment, will be more fully understood from the following specification and drawings, in which:

### DRAWING DESCRIPTION

FIG. 1 is a representation of an album, opened to show the front side of an album page and the rear side of the next album page;

FIG. 2 is an enlarged view of a corner section of the album page;

FIG. 3 is an edge view taken on lines 3-3 of FIG. 2;

FIG. 4 is a view like FIG. 3, but showing a modification; and

FIG. 5 shows a modification.

### DETAILED DESCRIPTION

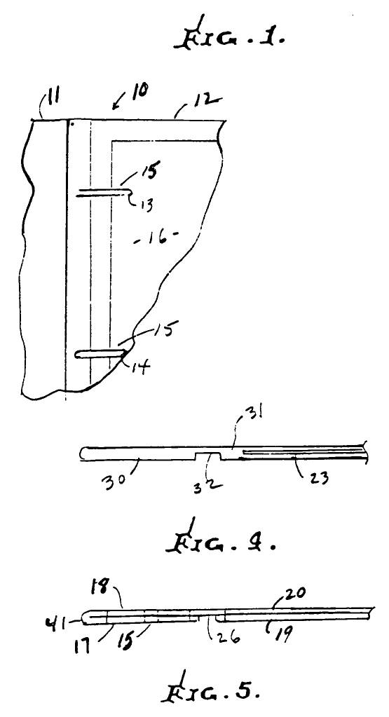

In FIG. 1, an opened album 10 has front and back covers 11 and 12, and metallic posts 13 and 14 extend through edge portions 15 of album page 16.

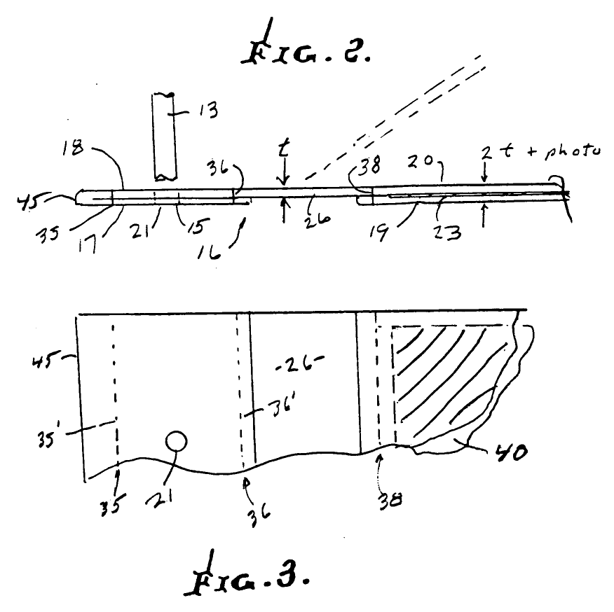

FIGS. 2 and 3 show construction of a representative page 16, in enlarged views. The page includes multiple plastic sheet layers, including:
a) first, second, third and fourth layers 17-20, each typically less than 1/16 inch thick, and extending in substantially parallel relation,
b) the first and second layers 17 and 18 extending in superposed relation, and defining a through opening or openings 21 to receive an album post or posts 13,
c) the third and fourth layers 19 and 20 also extending in generally superposed relation, in sidewardly offset relation to the first and second layers 17 and 18, and also defining a pocket 23 to receive a photo or other graphic sheet, indicated at 40,
d) and the second and fourth layers 18 and 20 interconnected at a layer 26, as in the form of an extension of 18 or 20, that defines a flexible page folding preferred locus 25, between the first and third layers 17 and 19.

FIG. 4 shows another form of the device, wherein layers 17 and 18 are unitary at 30; layers 19 and 20 are unitary at 31; and extension 32 between 30 and 31 is unitary with 30 and 31, and of lesser thickness than each of 30 and 31, to provide the preferred folding locus.

In FIGS. 2 and 3, the second and fourth layers 18 and 20 are configured as a common sheet of flexible plastic material.

Also provided are two primary rows of connections interconnecting said first and second layers, the through opening or openings located between said two primary rows, whereby the first and second layers are locally stiffened to resist folding, as at the post hole locations. See for example the two rows 35 and 36 of connectors 35′ and 36′, which may be provided by local heat joining of thermoplastic layers 17 and 18. Further, a secondary row 38 of such interconnections may be provided to join layers 19 and 20. The result is the provision of stiffening of layers 17 and 18 against bending and of layers 19 and 20 against bending, to the extent that preferred page folding is relegated to the locus of the narrow extension or band 26. This tends to keep the pocket 23 between layers 19 and 20 in straight and flat condition, and the layers 17 and 18 in unfolded, or lesser folded condition, as during page turning, to facilitate such turning, away from the album posts and the photo pocket, enhancing ease and efficiency of usage of the album.

Further features include multiple album pages as referred to which can be stacked, with through openings in successive pages being in alignment, and the folding zones 26 in superposed alignment. Also, the reduced thickness extensions 26 on successive pages at which folding preferably occurs, are left offset from the album posts, and are kept aligned in superposed relation, ready for localized folding.

FIG. 5 shows a modification, like FIG. 2, but in which the extension 26′ is reduced in width to a very narrow band, or line.

In FIGS. 2, 3, and 5, the layers 17 and 18 are shown as interconnected at edge fold 45. Extension 26 is typically between about ⅜ and ⅝ inch wide.

I claim:

1. An album page adapted for carriage by an album post or posts, comprising in combination:
a) first, second, third and fourth layers each less than 1/16 inch thick, and extending in substantially parallel relation,
b) the first and second layers extending in superposed relation and defining a through opening or openings to receive an album post or posts,
c) the third and fourth layers extending in generally superposed relation, in offset relation to the first and second layers, and defining a pocket to receive an album photo or other graphic sheet,
d) the second and fourth layers interconnected at a single thickness layer that defines a flexible page folding preferred locus, between the first and third layers.

2. The combination of claim 1 wherein said second and fourth layers are configured as a common sheet of flexible plastic material.

3. The combination of claim 1 wherein each of said layers consists of flexible plastic material.

4. The combination of claim 1 including a layer extension between said second and fourth layers, to provide said folding locus.

5. The combination of claim 4 including two primary rows of connections interconnecting said first and second layers, the through opening or openings located between said two primary rows, whereby the first and second layers are locally stiffened against folding, as at the post hole locations.

6. The combination of claim 4 including a secondary row of connections interconnecting said third and fourth layers whereby the third and fourth layers are locally stiffened against folding.

7. The multiple album pages as defined in claim 1 which are stacked, with said through openings in successive pages being in alignment, and the folding loci in alignment.

8. An album having front and back covers between which said multiple pages of claim 7 are located, there being an album post extending through the aligned openings in successive pages, said layer extensions of successive pages being offset from said port.

9. The combination of claim 4 wherein said layer extension extends lengthwise of the page and has width between about ⅜ inch and ⅝ inch.

10. The combination of claim 1 including a photograph or graphic sheet in said pocket, offset from said single layer whereby the folding locus is of thickness less than the combined thickness of the first and second layers, and also less than the combined thickness of the third and fourth layer.
